(19) United States
(12) Patent Application Publication
(10) Pub. No.: US 2005/0268088 A1
(43) Pub. Date: Dec. 1, 2005

(54) Vehicle control system, and in-vehicle control apparatus and mobile device used therefor

(75) Inventors: Jiro Okada, Tokyo (JP); Tadahiko Urano, Tokyo (JP); Yukihiro Hamamura, Hyogo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/962,436

(22) Filed: Oct. 13, 2004

(30) Foreign Application Priority Data
May 28, 2004 (JP) P2004-159314

(51) Int. Cl. H04L 9/00; H04L 9/32; G06F 11/30; G06F 12/14

(52) U.S. Cl. 713/153; 713/189

(57) ABSTRACT

A vehicle control system is such that a mobile device transmits a cipher code to an in-vehicle control device based on pre-stored data, and the in-vehicle control device decrypts the received cipher code based on pre-stored data, in order to output a necessary control signal to equipment mounted to a vehicle, the vehicle control system including: the mobile device and the in-vehicle control device each having a memory circuit for storing data for producing cipher related data including a cipher key and an ID code, which are a source of the cipher code; wherein the vehicle control system produces the cipher related data by reading out data in the memory circuits and subjecting the data to a predetermined process determined in advance, and performs production and decryption of the cipher code based on the produced cipher related data.

### BACKGROUND OF THE INVENTION

1. Field of the Invention

This invention relates to a vehicle control system for use in, for example, lock apparatus that control locking and unlocking of automobile doors and in so-called immobilizer apparatus that determine engine start permission.

2. Background Art

Vehicle control systems that have conventionally been used perform locking and unlocking of vehicle doors by operating a switch on a mobile device and permit starting of an engine by turning on an ignition switch with a key of a mobile device. These vehicle control systems are configured as follows; as shown in JP-A-11-117587, for example, a code is transmitted from a mobile device through wireless communication, which is received and verified with a stored code stored in an in-vehicle control device, and only when the results match, a control signal is output such that doors are locked or unlocked, or that starting of the engine is permitted. Further, a so-called smart key system has made its debut, in which the doors are unlocked when a user approaches the vehicle with merely carrying about a mobile device without operating it at all, and cipher verification is automatically carried out upon the user turning the ignition switch to permit starting of the engine.

As described above, cipher communication between an in-vehicle control device and a mobile device is to perform a control operation such that the in-vehicle control device verifies a stored code in the in-vehicle control device and a transmitted code from the mobile device to give a permission if they match and a non-permission if they do not match, regardless of whether or not the mobile device is operated. In addition, both the mobile device and the in-vehicle control device are equipped with data memory circuits for this purpose.

It is well known that these kinds of vehicle control systems have data memory circuits inside the mobile device and the in-vehicle control device, and when the respective apparatus are disassembled, the data memory circuits such as EEPROMs are incorporated. Normally, these kinds of data memory circuits store cipher related data, such as cipher keys and various ID codes, which are the source of the cipher communication method. Electronic engineers in this field will be able to access the cipher related data from the data memory circuits and decrypt the cipher communication method based on the cipher keys and ID data. Also, by decrypting the cipher related data from the devices, it is possible to abuse this communication, and therefore, the system has a problem in its security performance although it uses cipher communication.

This invention has been accomplished to solve the foregoing problem, and it is an object of the invention to provide a vehicle control system in which security performance of cipher communication is improved by making the cipher related data difficult to decrypt even when the data in the data memory circuit are accessed illicitly, as well as an in-vehicle control device and a mobile device for vehicle controlling that are used therefor.

### SUMMARY OF THE INVENTION

The invention provides a vehicle control system in which a mobile device transmits a cipher code to an in-vehicle control device based on pre-stored data, and the in-vehicle control device decrypts the received cipher code based on pre-stored data, in order to output a necessary control signal to equipment mounted to a vehicle, the vehicle control system comprising: the mobile device and the in-vehicle control device each having a memory circuit for storing data for producing cipher related data including a cipher key and an ID code, which are a source of the cipher code; wherein the vehicle control system produces the cipher related data by reading out data in the memory circuits and subjecting the data to a predetermined process determined in advance, and performs production and decryption of the cipher code based on the produced cipher related data.

With this vehicle control system of the invention, the security performance of cipher communication can be improved since the cipher related data become difficult to decrypt even when the data in the data memory circuit are accessed illicitly.

### BRIEF DESCRIPTION OF THE DRAWINGS

FIG. 1 is an overall configuration diagram illustrating a first embodiment of the invention;

FIG. 2 is a chart for explaining a communication method in the first embodiment of the invention; and

FIG. 3 is overall configuration diagram illustrating a second embodiment of the invention.

### DESCRIPTION OF THE PREFERRED EMBODIMENTS

### First Embodiment

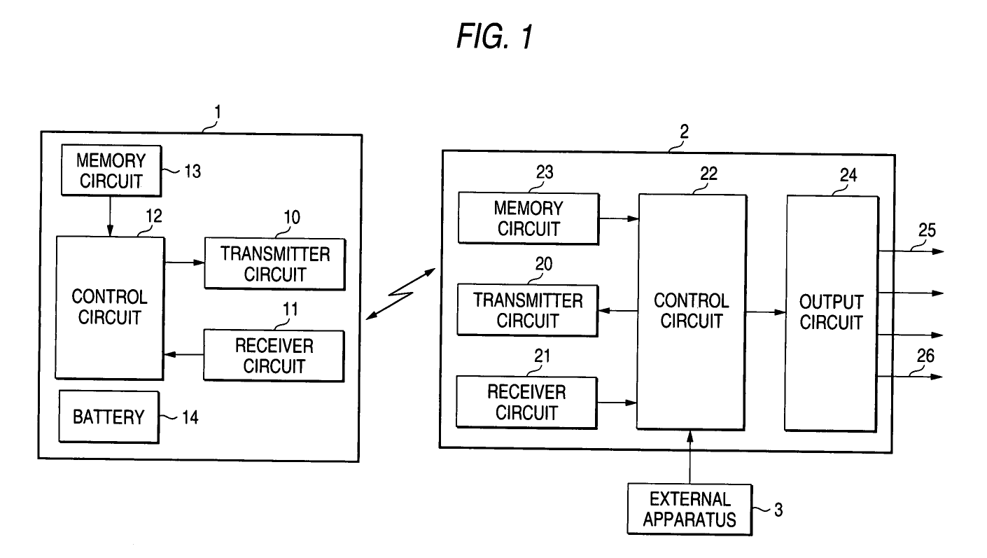

FIG. 1 is a block diagram illustrating the overall configuration of a vehicle control system according to a first embodiment of the invention. This vehicle control system includes a mobile device 1 and an in-vehicle control device 2, which is incorporated in a vehicle. The mobile device 1 includes a transmitter circuit 10, a receiver circuit 11, a control circuit 12, a memory circuit 13 for producing ciphers, and a battery 14. On the other hand, the in-vehicle control device 2 includes a transmitter circuit 20, a receiver circuit 21, a control circuit 22, a memory circuit 23 for decrypting ciphers, and an output circuit 24.

Here, the memory circuits 13 and 23 store data for producing cipher related data such as cipher keys and ID codes, which are the source of cipher code. By reading out the data of these memory circuits and subjecting them to a predetermined process, cipher related data such as a cipher key and an ID code are produced, and based on the produced cipher related data, a cipher code is produced or a received cipher code is decrypted.

Next, operations of each of the circuits are explained. First, a trigger signal for verifying ciphers is transmitted wirelessly from the in-vehicle control device 2 through the transmitter circuit 20 to a transmission line 4. If a user carrying the mobile device 1 is present within the area of the transmission, the receiver circuit 11 of the mobile device 1 receives this signal. The control circuit 12 of the mobile device 1 determines from this received signal whether or not to transmit a cipher code. This may be performed instead by the judgment of whether or not a so-called ID code has been received. That is, by determining from which vehicle the transmitted code is sent, the mobile device responds only to a code that is sent from the user's own vehicle. The control circuit 12 retrieves data for producing cipher related data such as a cipher key and an ID code from the memory circuit 13, and using this data, produces an encrypted cipher code based on the ID code and the cipher key, and wirelessly transmits the cipher code through the transmitter circuit 10 to the transmission line 4.

It should be noted that the battery 14 is an electric power supply for operating each of the circuits. The electric power is temporarily shut off from the end of the transmission until the receipt of the next signal so that electric power will not be consumed. The battery operates to start up the device by a receiving signal to supply electric power, and therefore, the device is of power-saving type by which power consumption is suppressed.

The in-vehicle control device 2 receives the cipher code transmitted from the mobile device 1 through the receiver circuit 21; the control circuit 22 retrieves data for producing cipher related data such as a cipher key and an ID code from the memory circuit 23, and using this data, it performs verification of the ID code and decryption of the cipher code, which is a command from the mobile device 1, based on the cipher key. Based on the command obtained by matching the ID code and decrypting the cipher code, the output circuit 24 outputs a control signal 25 such that, for example, the doors will be unlocked if locked, or conversely, the doors will be locked if unlocked. In addition, when turning an ignition key, the in-vehicle control device operates so as to output an engine start permission/non-permission signal 26 to an engine control device (not shown in the figures).

It should be noted that an external apparatus 3 is an apparatus that is capable of detecting door lock/unlock status, receiving signals from the engine control device, and detecting the state outside the vehicle.

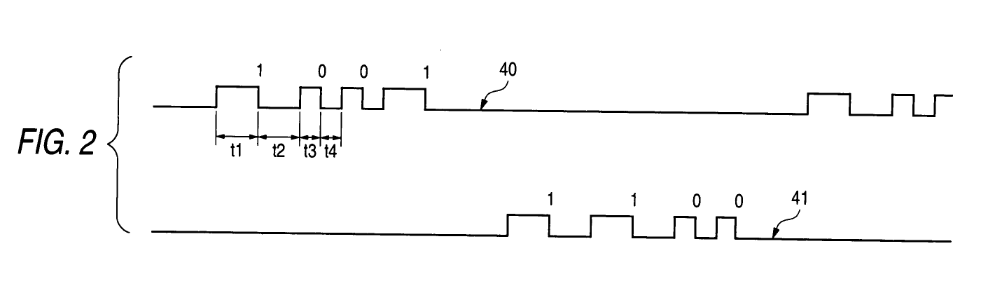

Next, details of communication mode is explained. When the communication mode of the wireless communication is, for example, PWM (pulse-width modulation system), communication is carried out as shown in FIG. 2. First, a transmission code 40 is transmitted from the in-vehicle control device 2 to the mobile device 1. Due to PWM communication, the case in which an H level time of a predetermined time (t1) is longer than a predetermined value (ta) is determined to be “1”, whereas the case in which the H level time is shorter than a predetermined value (tb) is determined to be “0”. In addition, a blank time is t2 in an H level, whereas a blank time in an L level is t3. According to this communication format, it is understood that the transmission code 40 that has been transmitted will be “1001”. If the mobile device 1 receives this and the control circuit 12 judges that it is a signal from the user's own vehicle, the mobile device sends back a response; conversely, if the control circuit judges that it is not a signal from the user's own vehicle, the mobile device does not send a response at all. Here, the data related to the code of user's own vehicle can be stored in the memory circuit 13, and the stored data are retrieved and verified. If the control circuit judges that the signal is the transmission code from the user's own vehicle, the control circuit retrieves data from the memory circuit 13, and produces an ID code 41 using the retrieved data, and transmits the code through the transmitter circuit 10. Here, data “1100” are transmitted utilizing PWM communication in a similar manner.

The in-vehicle control device 2 receives the ID code 41, and the control circuit 22 retrieves data from the memory circuit 23 and verifies them. Authorization between the mobile device 1 and the in-vehicle control device 2 is completed only when a match is obtained with the data “1100” as a result of the verification, and next, cipher communication for a control operation is started. The in-vehicle control device 2 judges that the user desires unlocking of the doors since the doors are locked; it retrieves data for producing cipher related data such as a cipher key and an ID code from the memory circuit 23, and produces a cipher key using the retrieved data. It converts a communication code for controlling doors into a cipher code based on the cipher key and transmits the code. There are many ways for this conversion; for example, there are a method in which a communication code is subjected to four basic arithmetic operations a predetermined number of times in a predetermined sequence, and a rolling method in which a communication code is shifted in sequence using a predetermined rule. The cipher key is the key for producing/decrypting the cipher that is the source of these methods. With this cipher key, the cipher code is once again transmitted from the in-vehicle control device 2.

Upon receiving this cipher code, the mobile device 1 retrieves data for producing cipher related data such as a cipher key and an ID code from the memory circuit 13, and using the data, it produces a cipher key. By carrying out a decrypt operation that is the reverse of the encryption, it is possible to judge the communicated content is permission/denial of a door locking/unlocking control operation. Then, the mobile device converts a communication code for approving the door control into an encrypted code and transmits the code.

The in-vehicle control device 2 receives the cipher code once again and decrypts the code based on the produced cipher key using the data stored in the memory circuit 23. Only then the in-vehicle control device 2 outputs a signal from the output circuit 24 such that the doors will be unlocked.

Thus, the cipher related data such as a cipher key and an ID code are the very key of this cipher communication. Therefore, the cipher related data are not stored as they are, but are stored in the memory circuits 13 and 23 in the form of data that have been converted using a predetermined rule; moreover, when reading out the data, they are converted with the predetermined rule to restore the cipher related data. Here, the converting of the data can be realized easily by subjecting the data to four basic arithmetic operations a predetermined number of times in a predetermined sequence.

For example, from an ID code “1001”, predetermined value “1111” is subtracted and thereafter exclusive OR-ed with a predetermined value “0011”, and the obtained value “0101” is stored. After reading out the data, the value is exclusive OR-ed with the predetermined value “0011”, and thereafter the obtained value is subtracted from the predetermined value “1111”. Thus, the ID code “1001” can be restored.

In this manner, even if the data stored in the memory circuits 13 and 23 become known, communication cannot be established since the data are neither a genuine cipher key nor ID code; therefore, improvement of security in communication can be easily achieved.

It should be noted that the memory circuit 13 of the mobile device 1 can also utilize a converted cipher key as with the memory circuit 23 of the in-vehicle control device 2. However, the necessity is not very high since the vehicle can be stolen if the mobile device 1 itself is stolen or picked up.

### Second Embodiment

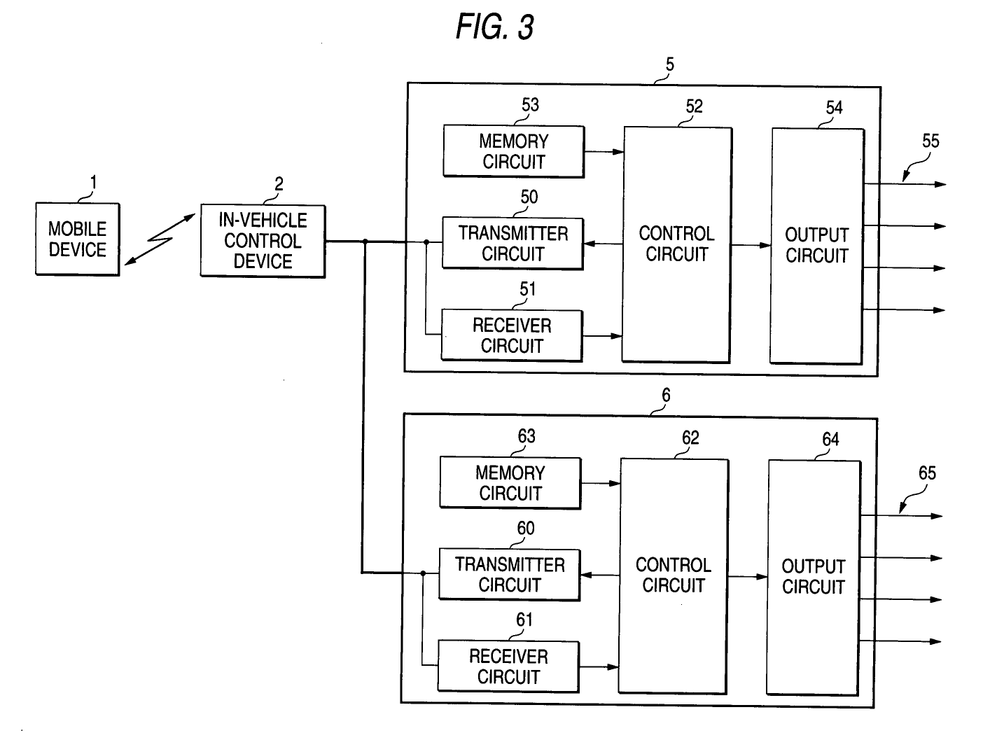

Next, a second embodiment is explained with reference to FIG. 3. The in-vehicle control device 2 that has been explained in the first embodiment is such that it communicates with the mobile device 1 and outputs a signal for controlling locking and unlocking of doors and a signal for permitting start of the engine. However, in actual vehicles, especially the control device for starting the engine is separately provided in most cases, and therefore, an engine control device 5, a body control device 6, and the in-vehicle control device 2 communicate with one another via a wire 7, for example.

The engine control device 5 includes, for communication, a transmitter circuit 50, a receiver circuit 51, a control circuit 52, a memory circuit 53, and an output circuit 54. Likewise, the body control device 6 includes a transmitter circuit 60, a receiver circuit 61, a control circuit 62, a memory circuit 63, and an output circuit 64. The engine control device 5 communicates with the in-vehicle control device 2, and when cipher verification is completed, it outputs an output signal 55 for instructing fuel supply, ignition, or the like, from the output circuit 54 to the engine. On the other hand, when the body control device performs cipher verification with the in-vehicle control device 2, the body control device 6 outputs a signal 65 for locking/unlocking of doors, for controlling anti-theft alarm, for instrument display, or the like.

These control devices 5 and 6 have memory circuits 53 and 63 for performing cipher communication with the in-vehicle control device 2. These memory circuits do not store genuine cipher keys but they store data for producing cipher related data such as a cipher key and an ID code, which become a source of the cipher code, as in the first embodiment. Therefore, the devices that are controlled by the respective control apparatus do not operate even when a vehicle theft is attempted, and therefore, the security performance is further improved.

1. A vehicle control system in which a mobile device transmits a cipher code to an in-vehicle control device based on pre-stored data, and the in-vehicle control device decrypts the received cipher code based on pre-stored data, in order to output a necessary control signal to equipment mounted to a vehicle, the vehicle control system comprising:
the mobile device and the in-vehicle control device each having a memory circuit for storing data for producing cipher related data including a cipher key and an ID code, which are a source of the cipher code; wherein
the vehicle control system produces the cipher related data by reading out data in the memory circuits and subjecting the data to a predetermined process determined in advance, and performs production and decryption of the cipher code based on the produced cipher related data.

2. The vehicle control system according to claim 1, wherein the memory circuits store a plurality of data for producing the cipher related data, and the cipher related data are produced by subjecting the respective data to different predetermined processes determined in advance.

3. The vehicle control system according to claim 1, further comprising an engine control device that communicates with the in-vehicle control device to control fuel supply and ignition of an engine, the engine control device having a memory circuit for storing data for producing cipher related data including a cipher key and an ID code, which are a source of the cipher code.

4. The vehicle control system according to claim 1, further comprising a body control device that communicates with the in-vehicle control device to control locking and unlocking of a door, the body control device having a memory circuit for storing data for producing cipher related data including a cipher key and an ID code, which are a source of the cipher code.

5. An in-vehicle control device for transmitting and receiving a cipher code to and from a mobile device in order to control equipment mounted to a vehicle based on the cipher code, the in-vehicle control device comprising:
a memory circuit for storing data for producing cipher related data including a cipher key and an ID code, which are a source of the cipher code; wherein
when communicating with the mobile device, the in-vehicle control device produces the cipher related data based on data read out from the memory circuit, and based on the cipher related data, the in-vehicle control device produces the cipher code or decrypts the cipher code transmitted from the mobile device.

6. A vehicle control mobile device for transmitting and receiving a cipher code to and from a mobile device in order to control equipment mounted to a vehicle based on the cipher code, the vehicle control mobile device comprising:
a memory circuit for storing data for producing cipher related data including a cipher key and an ID code, which are a source of the cipher code; wherein
when communicating with the in-vehicle control device, the mobile device produces the cipher related data based on data read out from the memory circuit, and based on the cipher related data, the mobile device produces the cipher code or decrypts the cipher code transmitted from the in-vehicle control device.
